(19) United States
(12) Patent Application Publication
(10) Pub. No.: US 2003/0206502 A1
(43) Pub. Date: Nov. 6, 2003

(54) Method and apparatus for providing motor control in an optical disk drive system

(76) Inventor: Xiao Lin, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 10/138,280

(22) Filed: May 2, 2002

(51) Int. Cl. G11B 7/085

(52) U.S. Cl. 369/30.15

(57) ABSTRACT

The present invention is a method and system to provide step motor control in an optical storage medium. The system comprises a light source that generates a beam of light and an optical disk that reflects the beam of light. The optical disk has a plurality of tracks. The system further comprises a detector for receiving the reflected beam and a control circuit coupled to the detector. The control circuit provides a step signal in response to the reflected beam. The step signal has a value corresponding to an operational mode of the control circuit. A step motor coupled to the control circuit and the light source drives the light source across the disk by a predetermined step based on the step signal.

### BACKGROUND OF THE INVENTION

1. Field of the Invention

The present invention relates in general to optical disk storage systems and more particularly, to a method and apparatus for providing motor control in an optical disk drive system.

2. Description of the Related Art

In recent years, optical disk devices have been used to record or reproduce large amounts of data. Optical disks are storage mediums from which data is read and to which data is written by laser. Each optical disk can store a large amount of data, typically in the order of 6 gigabytes.

Optical disks typically include spiral-shaped groove tracks having concave and convex portions, typically referred to as pits and lands respectively, formed on the surface of a disk substrate. On the surface of the substrate, a thin film that includes a recording material as a component is attached. During fabrication of the disks, concave and convex portions are often formed on the recording surface, simultaneously with the formation of guide grooves for tracking control, so as to record address information of each sector.

Optical disk drive systems typically include an optical pickup that may read recorded digital signals by detecting a laser beam that is reflected off the pits and lands. The optical disk drive system may also include a spindle motor for rotating the optical disk, and a sled motor for moving the optical pickup radially across the disk. Such sled motors are typically driven by analog output signals. Where the optical disk drive system is required to drive the sled motor in a step-wise manner, considerable firmware must be implemented to convert the analog signal to digital signals. Such firmware is typically complex and result in occupying a large portion of the limited storage in the firmware. As a result, the firmware bandwidth is decreased, access time is reduced, and cost is increased.

Accordingly, there is a need in the technology to overcome the aforementioned problems.

### SUMMARY

The present invention is a method and system to provide step motor control in an optical storage medium. The system comprises a light source that generates a beam of light and an optical disk that reflects the beam of light. The optical disk has a plurality of tracks. The system further comprises a detector for receiving the reflected beam and a control circuit coupled to the detector. The control circuit provides a step signal in response to the reflected beam. The step signal has a value corresponding to an operational mode of the control circuit. A step motor coupled to the control circuit and the light source drives the light source across the disk by a predetermined step based on the step signal.

### BRIEF DESCRIPTION OF THE DRAWINGS

FIG. 1 illustrates one embodiment of an optical disk apparatus provided in accordance with the principles of the invention.

FIG. 2 illustrates one embodiment of the step motor control block 150 of FIG. 1.

FIG. 3A illustrates one example of the timing signals and DCO output signals provided in accordance with the principles of the invention.

FIG. 3B illustrates one example of a look-up table used for converting frequency to oscillation counts, provided in accordance with the principles of the invention.

FIG. 3C is a graph that illustrates a comparison between the conversion values provided by the lookup table in FIG. 4A and those provided under ideal conditions.

FIG. 4A illustrates one embodiment of a table used to provide micro stepping.

FIG. 4B illustrates one embodiment of a table used to provide accelerated micro stepping.

FIG. 5 illustrates a second embodiment of a step motor control block 150a of FIG. 1.

FIG. 6A illustrates one embodiment of a register used for step motor control.

FIG. 6B illustrates one embodiment of a plurality of sampling rates used to provide the track-to-go count.

FIG. 6C illustrates one embodiment of the gain values corresponding to the accumulator clock frequency and bit values for the control register of FIG. 6A.

FIG. 7 illustrates one embodiment of a speed profile table used to provide the speed profile settings as shown in FIG. 1 and/or FIG. 5.

FIG. 8 illustrates one embodiment of the register layout of a rough search timer unit used to provide various parameters for operating in the rough search mode.

FIG. 9 illustrates one embodiment of a register layout for the Track Count Threshold unit of FIG. 5.

FIG. 10A illustrates one embodiment of a register layout for the tables for providing micro stepping and accelerated micro stepping.

FIG. 10B illustrates one embodiment of a register layout for providing entries corresponding to DAC1 values.

FIG. 10C illustrates one embodiment of a register layout for providing entries corresponding to DAC2 values.

### DETAILED DESCRIPTION OF THE EMBODIMENTS

One aspect of the present invention is an apparatus and method for providing sled motion control in an optical disk system. The apparatus includes a step motor that provides sled motion in the optical disk system. In one embodiment, the step motor is a 2-winding 4-phase phase modulated step motor. In one embodiment, the motor driver is bipolar and receives analog inputs from a digital-to-analog converter in the control circuitry.

A further aspect of the invention involves providing sled motion control in three different operational modes. These modes include a tracking mode, a fine seek mode and a rough search mode. In one embodiment, the tracking mode is a normal mode, the fine seek mode is a seek action that is initiated when a search within (i.e., at or less than) a predetermined number of tracks (for example, at or below 2048 tracks) is involved, while the rough search mode is a search action that is initiated when a search that exceeds the predetermined number of tracks (for example, over 2048 tracks) is involved. In one embodiment, the rough search mode includes two sub-modes of operation, namely, a manual mode and an automatic mode.

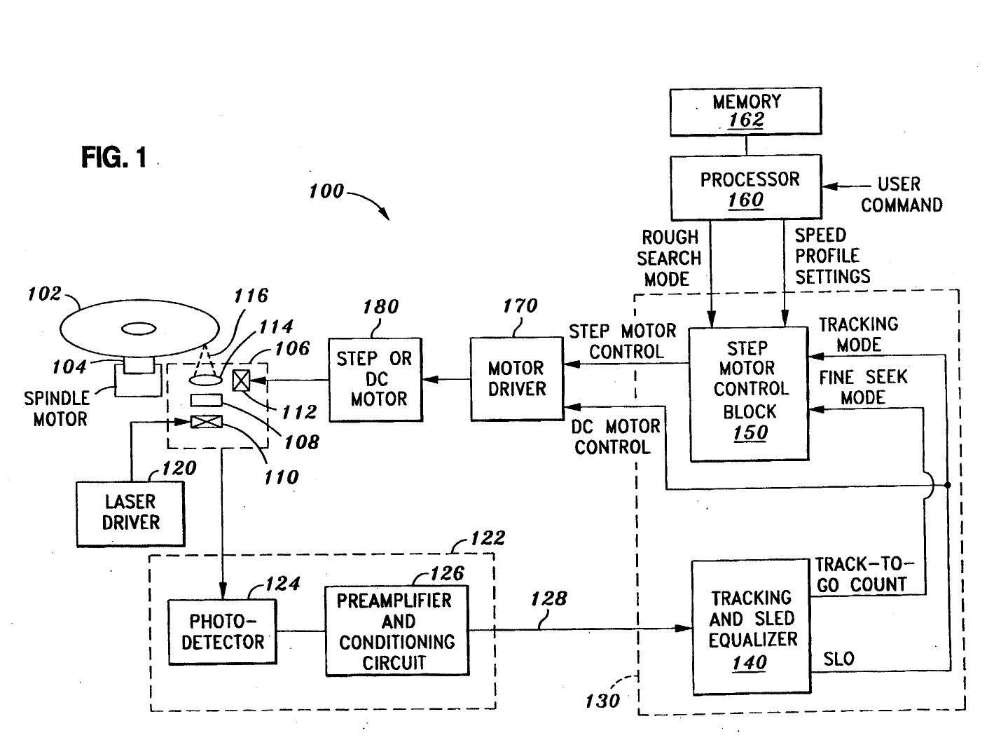

FIG. 1 illustrates one embodiment of an optical disk apparatus 100. The optical disk apparatus 100 includes an optical disk 102 that is rotated by a spindle motor 104. An optical pickup 106 scans the tracks on the rotating disk 102 with a laser beam. The optical pickup 106 comprises an optical system including a laser 108 that provides a light source, and an objective lens 114. The laser 108 is driven by a laser driver 120 via a focus actuator 110 to emit a laser beam 116. The focus actuator 110 is driven by the laser driver 120 to focus on various portions of the disk 102. The laser beam 116 is incident on the objective lens 114 via optical elements (not shown) such as a collimator lens and a beam splitter. The laser beam 116 is focused by the focus actuator 110 on the recording surface of the optical disk 102 by the objective lens 114 to form a small spot on the recording surface. The light reflected from the optical disk 102 propagates back to the objective lens 114 and is separated from the incident laser beam by the beam splitter. The reflected light beam is detected by the photodetector 124. This photodetector 124 converts this reflected light beam into an electric signal.

The electric signal is then provided to a preamplifier and conditioning circuit 126, which amplifies and conditions the electric signal. Based on the received electric signal, the preamplifier and conditioning circuit 126 generates a plurality of signals, including a track error signal, a focus error signal and a beam strength signal via signal line 128. The beam strength signal is a signal generated from either the main or the side beams of the reflected light beam, or a combination of both the main and side beams, and it represents the disk reflection of the beam spot as the optical head moves across the disk surface. The tracking error signal represents the tracking servo quality based on the reflected light beam. It is understood that additional signals may be provided by the circuit 126.

The signals are provided via signal line 128 to the control block 130. In particular, the tracking error signal is provided to a tracking and sled equalizer 140, which generates a Sled Level Output (SLO) signal which controls the motion of the sled motor and a Track-to-Go Count, which provides a count of the number of tracks to cover in the fine seek mode. These two signals are provided to the Step Motor Control Block 150. The Step Motor Control Block 150 also receives two inputs from a processor 160. These inputs, which may be provided via a single signal line or on multiple signal lines, may include a rough search mode control signal and speed profile settings. The Step Motor Control Block 150 generates control signals to a Motor Driver 170 for controlling the radial direction and magnitude for driving the optical pickup 106. In one embodiment, the Motor Driver 170 comprises a Step Motor Driver. In an alternate embodiment, the Motor Driver 170 comprises a D.C. Motor Driver. The D.C. Motor Driver receives analog inputs while the Step Motor Driver receives digital inputs. For discussion purposes, the Step Motor Driver or D.C. Motor Driver is considered to be represented by a single block 170. The Motor Driver 170 may also receive control signals (such as SLO signals) from the Tracking and Sled Equalizer 140 for controlling the movement of the D.C. Motor Driver. The Motor Driver 170 in turn drives the Step or D.C. Motor 180. The Motor 180 supplies a drive current to the tracking actuator 112 to drive the tracking actuator 112. In response, the tracking actuator 112 moves the objective lens 114 in the radial direction of the optical disk 102.

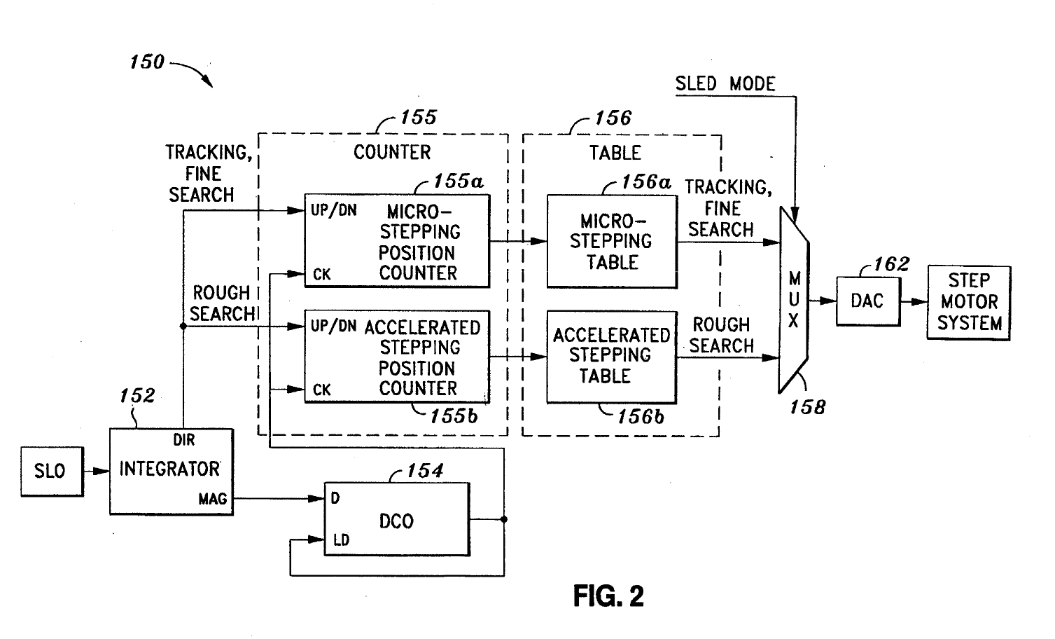

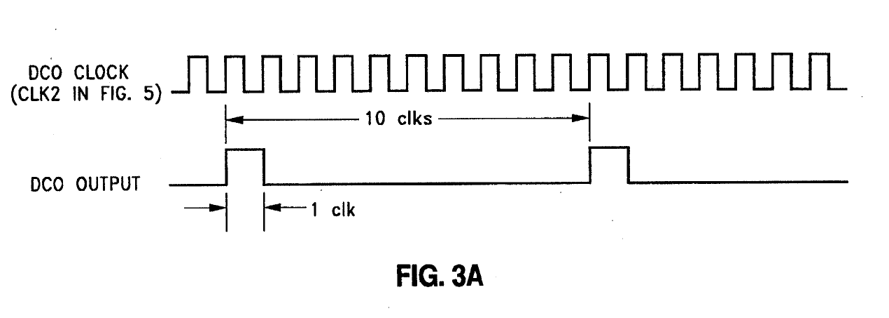

FIG. 2 illustrates one embodiment of the step motor control block 150 of FIG. 1. An Integrator 152 in the Step Motor Control block 150 receives the SLO signal from the Tracking and Sled Equalizer 140. The Integrator 152 limits the SLO signal (to a predetermined range) and generates two output signals, a magnitude signal MAG and a direction signal DIR. The MAG and DIR signals are received by a Digital Control Oscillator (DCO) 154 and a Position Counter block 155 respectively. The MAG signal represents the magnitude or speed of progressing through the steps in the position counter block 155, while the DIR signal represents the direction of movement (e.g., increasing or decreasing) through the steps in the position counter block 155. The DCO 154 receives MAG, which is a frequency input signal, and converts it to pulses having rising edges that are separated by an interval representing the input frequency. For example, for input frequency values that are between 16-63, the DCO output will have a rising edge for every 10 clock cycles. FIG. 3A illustrates one example of the timing signals and DCO output signals provided in accordance with the principles of the invention.

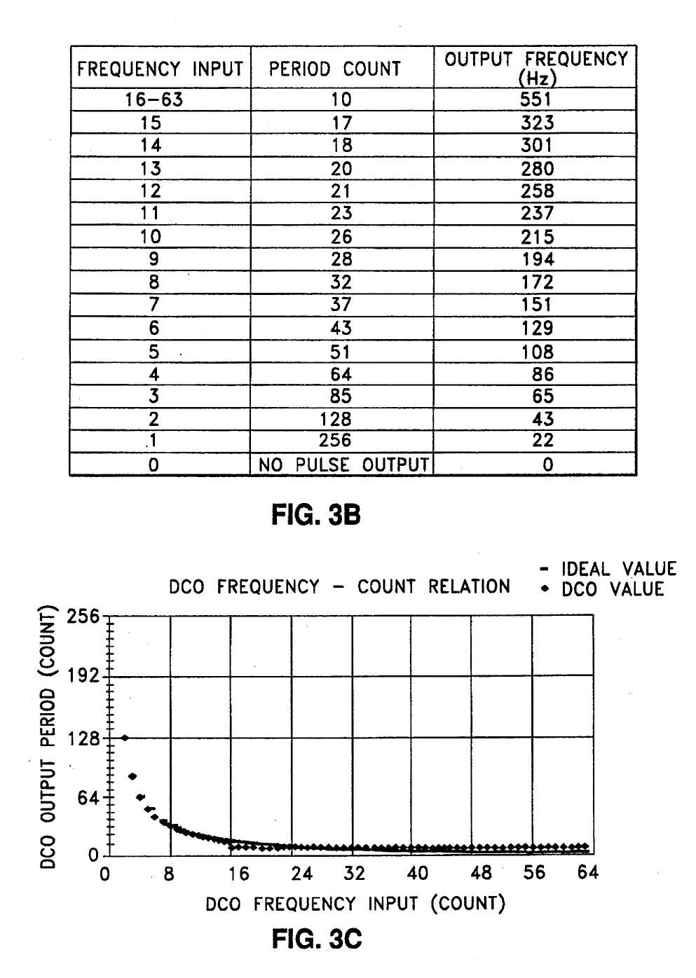

In one embodiment, the pulse periods are counted using a clock with a frequency of 4×1378 Hz. Whenever counting for a particular period is completed, the DCO loads the latest frequency input. FIG. 3B illustrates one example of a look-up table used for converting frequency to oscillation counts. FIG. 3C is a graph that illustrates a comparison between the conversion values provided by the lookup table in FIG. 4A and those provided under ideal conditions. As can be observed, the DCO values used are close to those provided under ideal conditions.

The counter block 155 comprises a micro-stepping position counter 155a and an accelerated micro stepping position counter 155b. The first counter 155a receives output signals from the Integrator 152 representative of a tracking and fine search mode, while the second counter 155b receives output signals from the Integrator 152 representative of a rough search mode. The Table block 156 comprises a micro stepping table 156a and an accelerated micro stepping table 156b, which receive inputs from the counter 155a and 155b respectively. Thus, during the rough search mode, an accelerated process is implemented to quickly move through the tracks. Each counter 155a or 155b provides a pointer to each table 156a or 156b to determine the digital values used to drive the motor 180. FIG. 4A illustrates one embodiment of a table used to provide micro stepping, while FIG. 4B illustrates one embodiment of a table used to provide accelerated micro stepping. The multiplexor MUX 158 selects one of the two outputs from 156a and 156b and provides the resulting output signal to DAC 162, which generates an analog signal for driving the Motor 180.

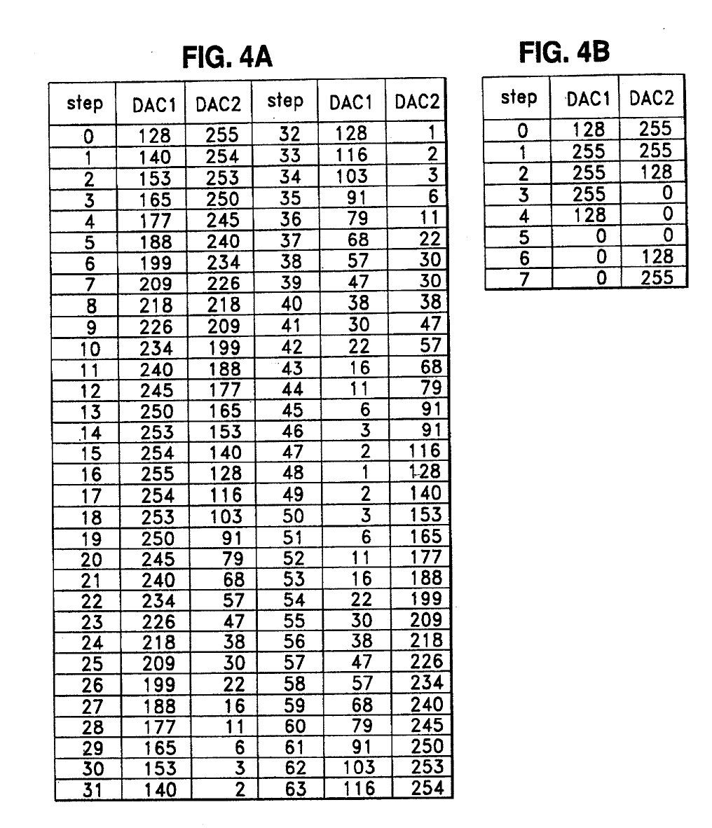

FIG. 5 illustrates a second embodiment of a step motor control block 150a of FIG. 1. The step motor control block 150a provides sled motion control. In one embodiment, sled motion control may be provided in 3 different modes, namely, the tracking, fine seek and rough search modes, as described earlier. Each of the modes is activated through setting of a bit in a storage such as a register. The register may be stored in memory such as memory 162 (FIG. 1). In one embodiment, the TSON, SRCH and PUFWD/PUBWD bits in the register corresponding to the tracking, fine search and rough search modes respectively, are used to determine which of the modes is activated. Additionally, the seek direction (FWD/BWD) bits in the register also provide the direction of the sled motor, i.e., whether the counter corresponding to the sled motor movement should be increased or decreased.

With reference to FIG. 5, the SLO signal, which is typically provided from the Tracking and Sled Equalizer 140 (FIG. 1) is provided to an integrator block 200. An integrator 202 accumulates the SLO signal and provides outputs representing the magnitude (MAG) and direction (FWD/BWD) of the SLO signal. The magnitude represents the number of steps to cover during the search, and the direction represents moving forward (FWD) of backwards (BWD) with respect to a current track.

The direction (FWD/BWD) signal is provided as one input to multiplexor (MUX) 254. A limiter 202 clips or limits the signal MAG to a first predetermined range, provides it to a gain circuit 206, which subsequently provides the signal to a second limiter 208 which limits the signal to a second predetermined range. The output of the limiter 208 represents the step frequency to be used. The step frequency is provided to a Digital Control Oscillator (DCO) 210 and converts the step frequency input to pulses having rising edges that are separated by an interval representing the input frequency. For example, for input frequency values that are between 16-63, the DCO output will have a rising edge for every 10 clock cycles. FIG. 3A illustrates one example of the timing signals and DCO output signals provided in accordance with the principles of the invention.

In one embodiment, the pulse periods are counted using a clock with a frequency of 4×1378 Hz. Whenever counting for a particular period is completed, the DCO loads the latest frequency input. FIG. 3B illustrates one example of a look-up table used for converting frequency to oscillation counts. FIG. 3C is a graph that illustrates a comparison between the conversion values provided by the lookup table in FIG. 4A and those provided under ideal conditions. As can be observed, the DCO values used are close to those provided under ideal conditions. The DCO 210 provides an output that is forwarded as one input to multiplexors (MUX) 220, 222 and 252.

When normal tracking is initiated through the activation of the TSON signal (see details below), MUXes 252 and 254 are instructed to latch the inputs from the SLO (via integrator 202) and DCO 210 and respectively provide outputs to a pointer block 256. In one embodiment, the pointer block 256 is a micro-stepping position counter having 64 pointer values, from 0-63. The output of MUX 252 will be provided as a counter input CK while the output from MUX 254 will be provided as an input to an up/down (UP/DN) counter. The output of the pointer block 256 is a step position and it points to a table having micro-stepping position values 258. The output of the table is provided to MUX 262, which receives instructions from TSON to latch the table value and provide it to DAC circuit 270.

When a fine seek mode is initiated through the activation of the SRCH signal (see details below), MUXes 252 and 254 are instructed to latch the inputs from the Tracks-to-Go Counter 142 (only if the value in the Counter 142 is equal to or greater than the threshold value in the Track Count Threshold block 144), and the seek direction (FWD/BWD) signal. The Muxes 252 and 254 respectively provide outputs to a pointer block 256. The output of the pointer block 256 is a step position and it points to a table having micro-stepping position values 258. The output of the table is provided to MUX 262, which receives instructions from SRCH to latch the table value and provide it to DAC circuit 270.

A rough search mode may also be initiated. This mode includes two sub-modes, a manual rough search mode and an auto mode. When the manual rough search mode is initiated, the output of DCO 210 is provided to MUXes 220 and 222, as activated by the AUTO/MANUAL signal. The output of the MUX 220 is provided to the DAC 270 via MUX 260. The output of MUX 222 is provided as a counter input to an accelerated position counter 224. The counter 224 receives instructions for counting up or down from the integrator 202. The output of the accelerated position counter 224 is provided to MUX 262, which latches in the counter's 224 output as instructed by the PUFWD/PUBWD signal (which initiates the rough search). The counter 224 provides a pointer to table 225 to determine the digital values used to drive the motor 180. FIG. 4A illustrates one embodiment of a table used to provide micro stepping, while FIG. 4B illustrates one embodiment of a table used to provide accelerated micro stepping.

During the auto rough search mode, the Speed Profile Table 230 provides speed values that are provided to a rough seek step counter 242 via sample and hold circuit 234 and gain circuit 238. A detailed description is provided below. The output of the rough seek step counter is provided as input to the MUxes 220 and 222, which latch in the output of the rough seek step counter 220 when instructed by the AUTO/MANUAL signal. The output of the MUXes 220 and 222 are provided to the MUX 260 and the accelerated position counter 224, as described above.

Tracking Mode

The tracking mode is typically implemented during normal play. In this mode, the overall sled speed is typically about 200 ms/track under ideal conditions, for a 1X CLV to about 4 ms/track for 48X CLV (excluding radial run-out). The SLO signal is provided from the tracking and sled equalizer 140 (FIG. 1) and is sampled and accumulated by an integrator 202 in an integrator circuit 200. In one embodiment, the SLO signal is sampled at a clock rate determined by CLK5. In one further embodiment, CLK5 is about 1378 Hz. The magnitude of the resulting signal is provided to a limiter 204, gain circuit 206 and a second limiter 206, which generate a stepping frequency.

The stepping frequency is used to move the sled one step towards the direction (provided by FWD/BWD output) indicated by the sign of the averaged SLO signal. The maximum stepping frequency is limited by the resonance frequency of the stepper motor system 280 (FIG. 5), which in one embodiment, includes motor driver 170 and Motor 180 (FIG. 1). In one embodiment, the maximum stepping frequency may be set in firmware. Assuming that there is no saturation in the stepping frequency, the relationship between step frequency and the averaged SLO magnitude should be linear.

The stepping frequency is provided to a DCO 210 which provides one input to a mux 220. The DCO operates at a clock rate determined by CLK2, which in one embodiment, is 4 times that of CLK2. Depending on the implementation of the DCO 210, there may need to be a minimum stepping frequency. If the stepping frequency is below the minimum stepping frequency, then no stepping will take place until the next stepping frequency is available. The DCO 210 converts the stepping frequency values into timed pulses to update the DAC values from the stepping table.

Fine Seek Mode

The fine seek mode is selected for seeking tracks in a predetermined range. For example, if a track with a range of 2048 tracks is being searched, the fine seek mode is implemented. If a search is conducted over a range that is greater than 2048 tracks, a rough search mode is implemented.

The seeking process is initiated by a fine seek command from processor 160. The Tracks-to-Go value or an internal count of the tracks to cover for the search, is monitored by a Tracks-to-Go block 142 (FIG. 5) in the tracking and sled equalizer 140 (FIG. 1). In one embodiment, the Tracks-to-Go value is determined by the difference between the number of tracks to seek and the number of tracks already covered. The Tracks-to-Go value and is compared by a comparator 250 with a Track Count Threshold value in the Track Count Threshold block 144. If the Tracks-to-Go value is greater than the threshold value, a fine seek signal is issued and forwarded to MUX 252 and 260. The Track Count Threshold value is determined by the processor 160 and typically corresponds to the number of tracks covered by one micro-step motion.

Once the seek is performed, the TSON (tracking) bit will be set and the SRCH (fine seek) bit will be turned off, so that the step motor control block 150 will operate in the tracking mode again.

In one embodiment, the sampling rate of the Tracks-to-Go value should not exceed the step motor resonant frequency. This rate may be set through the use of a processor register. The SLO signal from equalizer 140 is also processed to provide the direction of the seek, i.e., whether the micro-stepping position pointer is to move up one index (FWD in block 202) or down one index (BWD in block 202).

Rough Search Mode

The rough search mode is typically implemented for seeks that are above the predetermined number of tracks, for example, above 2048 tracks. In this mode, an accelerated stepping process is implemented. In one embodiment, an accelerated micro-stepping or half-stepping process as described earlier, may be implemented. In a further embodiment, two operational rough search modes may be implemented—the manual and the auto modes.

Under the manual mode, the rough search is performed using the SLO signal to control the motion of the sled. In one embodiment, the signed SLO signal is sampled at a clock rate of 1378 Hz (same as the SLO refreshing rate) and accumulated continuously by integrator 202 to reflect the corresponding sled speed profile. The accumulated SLO will be converted through a gain Kstp (for example, provided via gain block 206) to the half stepping frequency. Kstp is programmable through use o the processor 160. The sign of the accumulated SLO is used to determine whether to increment or decrement the half-stepping or accelerated position pointer 224.

The DCO 210 performs the step timing control for the manual mode of the rough search. It converts the input step frequency values into timed pulses so that each pulse will cause the DAC values to be updated. The half-stepping position counter 224 is either incremented or decremented based on the sign bit of the accumulated SLO signal.

Under the auto mode, search is performed in an open loop. A preset speed profile table 230 is used to control the stepping process. In one embodiment, 16 steps are used for the whole rough search period. Each entry in the table specifies the number of counter values that correspond to the sled speed. A Timer Counter Unit 232 is used to define the time scale for the speed profile table.

At the beginning of a rough search, the first entry of the speed profile table is loaded into the Rough Search Step Counter 242. The sled will be moved by the step motor 12 step forward or backward in a step frequency specified by the first entry. The duration of this step frequency is controlled by the Timer Unit 232. Each stepping frequency will be used for the whole period of the Timer Unit 232. When this period expires, the Rough Search Index Counter will increase by one count, and the next entry in the Speed Profile Table 230 will be loaded into the Rough Search Step Counter 242. When the index reached the maximum number of steps (which in the present example is 16), an interrupt is issued by the processor to indicate the completion of the rough search.

In order to define the step frequency range, the minimum and maximum frequency that can be achieved by the system has to be known. The maximum stepping frequency is limited by the maximum stepping frequency of the step motor system. In one embodiment, it is under 1000 Hz. The minimum frequency is required to ensure that the rough search speed remains above a certain level, which is the minimum frequency level. A speed of 1000 tracks/sec can be used as the minimum limit. As one half step of the step motor may cover about 200 tracks, the minimum stepping frequency may be set around 5 Hz to obtain a track crossing speed of the order of 1000 tracks/sec.

Register Definition

A memory 162 may be used to store various values required for the operation of the different modes of operation. In one embodiment, the memory 162 may comprise a register. The following discussion provides one embodiment of the definition of the register.

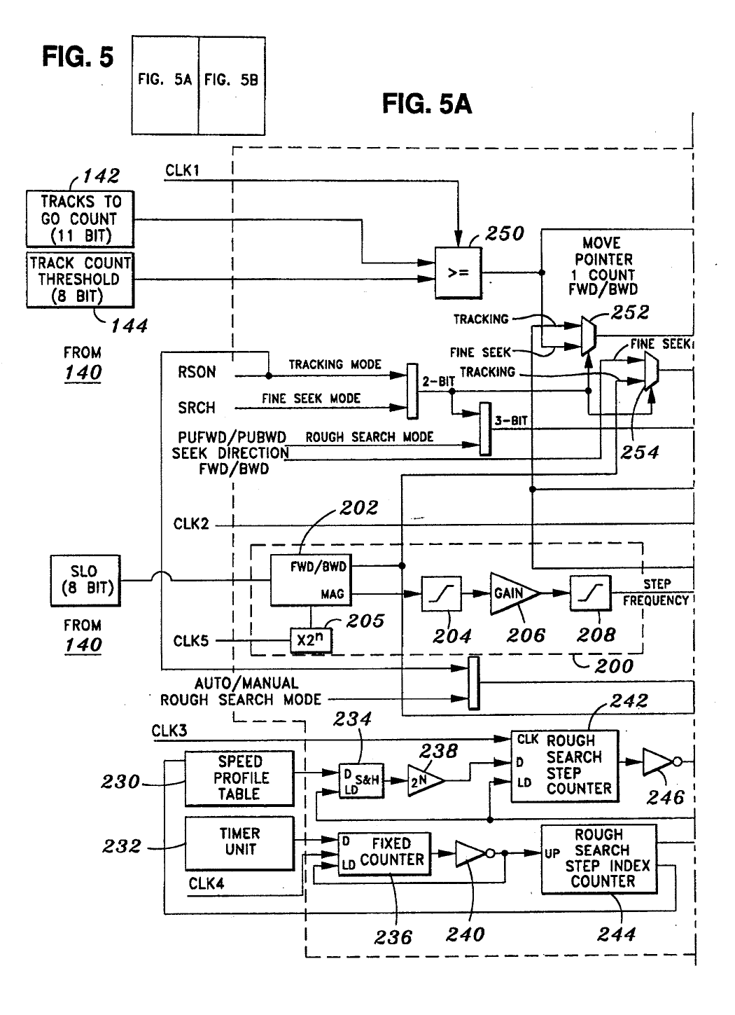

FIG. 6A illustrates one embodiment of a register used for step motor control. The register may include 8 bit values, where bits 0 and 1 define the sampling rate of the Tracks-to-Go value (Fclk1), bits 2-4 define the gain for the SLO (Kslo), bits 5 and 6 define the micro-stepping mode (MSTPMODE), and bit 7 determines whether an auto or manual mode is selected (RGHMODE). Other values in the register may include the name, type and address of the register.

In one embodiment, the micro-stepping mode includes 2 bits where 00, 01, and 10 represent a 16-step mode, an 8-step mode and a 4-step mode respectively, where 11 is reserved. In another embodiment, the sampling rate of CLK1 may be defined as follows. The bit values 11, 10, 01 and 00 represent 1378/8 Hz, 1378/4 Hz, 1378/2 Hz and 1378 Hz respectively. In addition, bits 4, 3 and 2 which hold the values for Kslo, may be represented as shown in FIG. 6B.

Speed Profile Table

As discussed earlier, when operating in the auto rough search mode, a speed profile table 230 has to be provided. The speed profile table provides the preset speed for the sled motor for a predetermined period of time.

For present discussion purposes, 16 entries are implemented in the speed profile table, each provided in units provided by the counter clock (CLK3) period. In one embodiment, the counter clock frequency is 11 kHz. The following expression may be used to convert the speed profile, Ntracks (tracks/sec) to speed provide entries Nclks (clock units/step) in the speed profile table 230:

$${N}_{table} = {2}^{- 3} * {f}_{CLK3} * \frac{{N}_{half}}{{N}_{tracks}}$$

Where N_{table} stands for the entries in the speed profile table,

f_{CLK3} is the clock frequency of the counter,

N_{half} is the number of tracks covered by one half step,

N_{tracks} is the desired tracks per second speed during rough search.

As an example, if a half step covers about 10² tracks, a table value of 1 corresponds to the maximum seeking speed of 137,800 tracks/sec (to provide a stepping frequency of about 1.4 kHz), while a maximum entry of 255 corresponds to about 540 tracks/sec (to provide a stepping frequency of about 5 Hz).

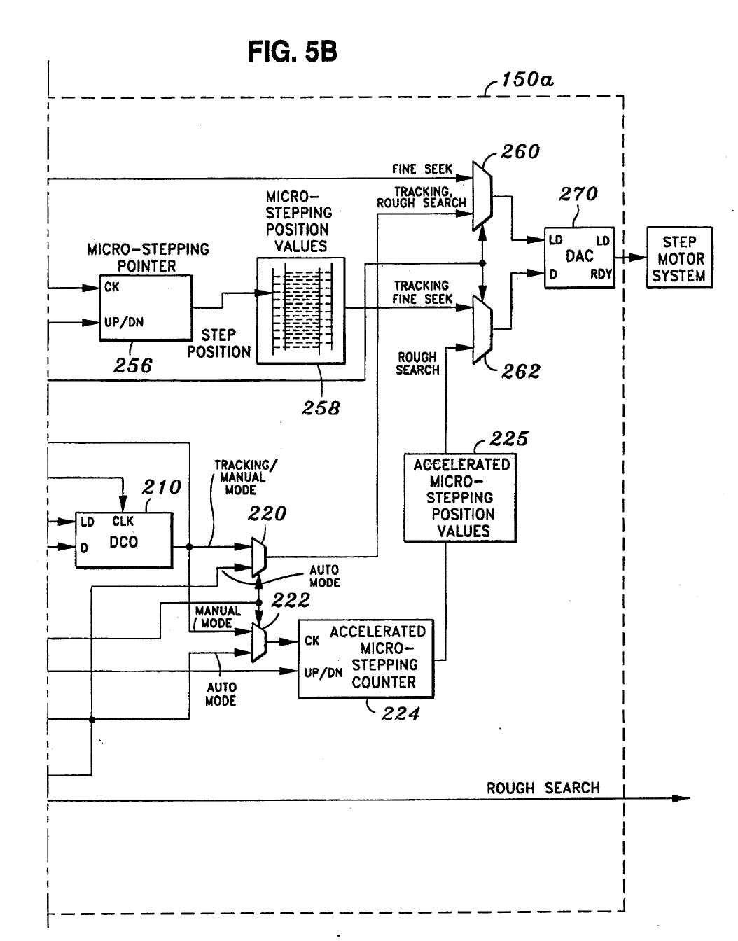

FIG. 7 illustrates one embodiment of a speed profile table used to provide the speed profile settings as shown in FIG. 1 and/or FIG. 5. The registers RGHSPD0-RGHSPDF may be defined through the use of an 8-bit register as shown in FIG. 7.

Rough Search Timer Unit

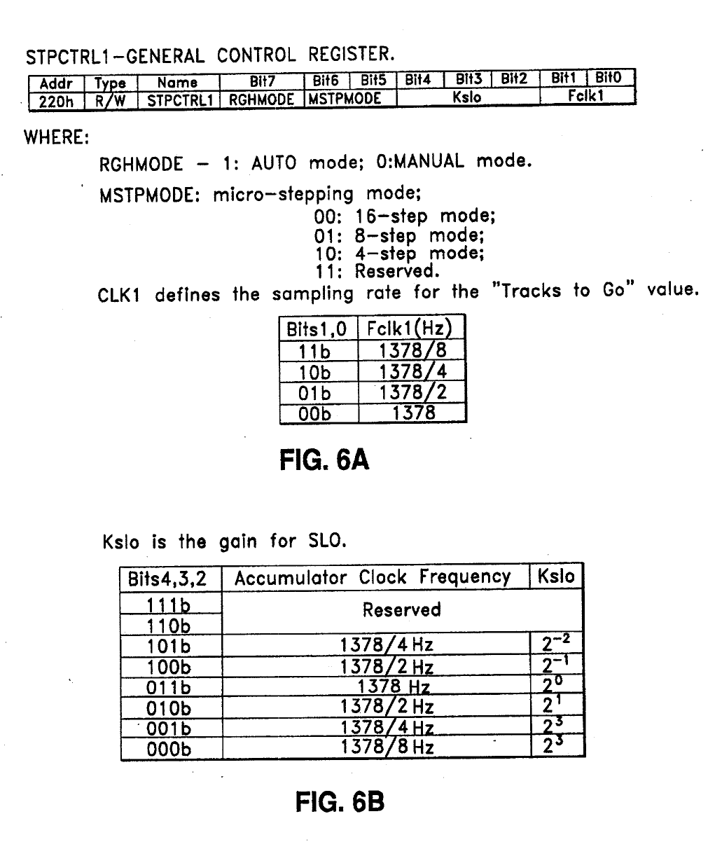

FIG. 8 illustrates one embodiment of the register layout of a rough search timer unit used to provide various parameters for operating in the rough search mode. The register may include 8 bits for defining RGHSTP, which is the time duration for one of the 16 step motor speeds specified in registers RGHSPD0-F. A unit of 0 is not valid.

The actual time duration for each rough search speed may be calculated using the following expression:

T=RGHSTP/1.378(ms).

Using this definition, the maximum time duration permitted is 185 ms, that is, 1/16^{th} of a whole rough search period.

Track Count Threshold—for Fine Seeks

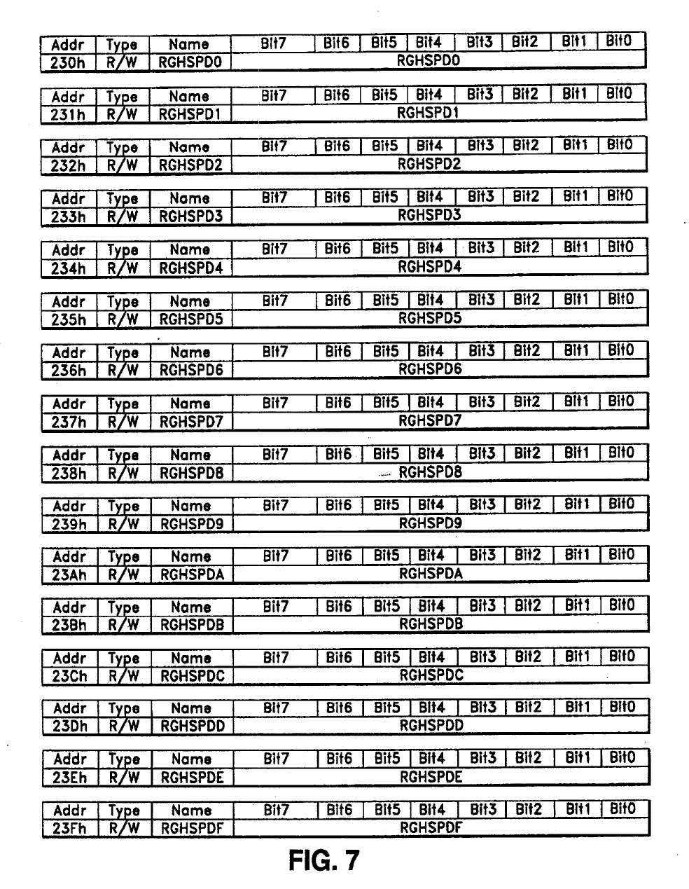

FIG. 9 illustrates one embodiment of a register layout for the Track Count Threshold unit of FIG. 5. The register includes 8 bits that represent the number of tracks equal to or above which the sled will be moved one micro-step.

Register Layout for Micro Stepping

In one embodiment, there are 64 2×8 bit entries for the micro stepping table. STPADD represents the address offset of the table entry. Offset values from 00h to 3Fh correspond to the 64 micro-steps in a full cycle. The half-stepping table has 8 2×8 bit entries. Offset values of 40h to 47h correspond to the 8 half steps in a full cycle.

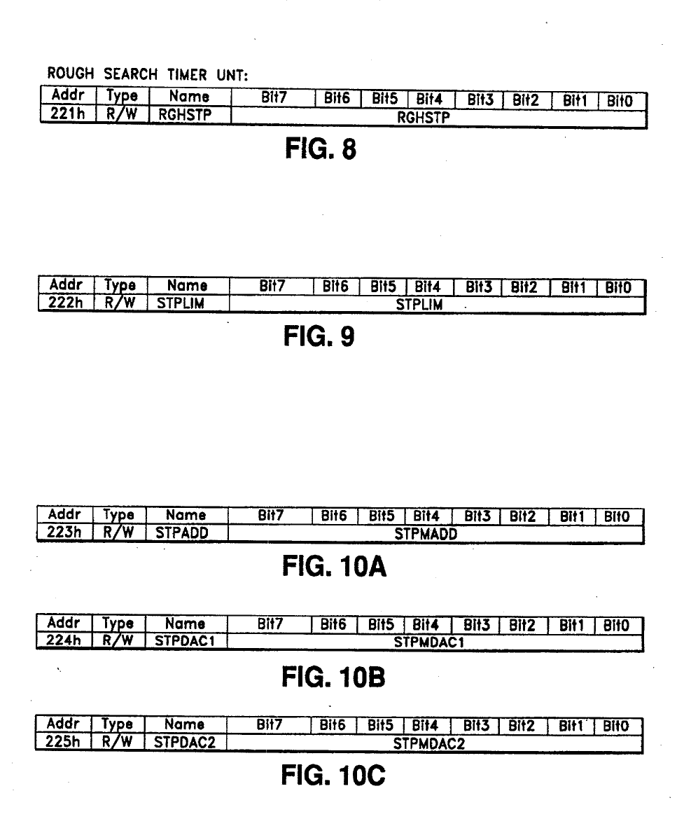

FIG. 10A illustrates one embodiment of a register layout for the tables for providing micro stepping and accelerated micro stepping.

In one embodiment, the step motor is a 2-winding 4-phase phase modulated step motor. The motor driver is bipolar and receives analog inputs from a digital-to-analog converter in the control circuitry. Since there are 2-windings in the motor, two DACs may be implemented to provide the required signals to each winding in the motor. Accordingly, two 8 bit DAC entries may be provided for each offset address specified. As shown in FIGS. 10B and C, STPDAC1 and STPDAC2 are the DAC values. FIGS. 10B and 10C also respectively illustrate one embodiment of a register layout for providing entries corresponding to DAC1 and DAC2 values.

Accordingly, the present invention effectively provides sled motion control in an optical disk system. It also provides three modes of operation for effectively providing tracking, fine seeks and rough searches.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system for providing step motor control in an optical storage medium, comprising:
a light source that generates a beam of light;
an optical disk that reflects the beam of light, said optical disk having a plurality of tracks;
a detector for receiving the reflected beam;
a control circuit coupled to the detector, said control circuit to provide a step signal in response to said reflected beam, said step signal having a value corresponding to an operational mode of said control circuit; and,
a step motor coupled to said control circuit and said light source, said step motor to drive said light source across said disk by a predetermined step based on said step signal.

2. The system as recited in claim 1, wherein said operational mode is a seek mode, and said value corresponds to a predetermined number of tracks to traverse.

3. The system as recited in claim 2, wherein said seek mode is a fine seek mode.

4. The system as recited in claim 2, wherein said seek mode is a rough seek mode.

5. The system as recited in claim 4, wherein said rough seek mode is initiated manually through user input.

6. The system as recited in claim 4, wherein said rough seek mode is initiated automatically.

7. The system as recited in claim 1, wherein said operational mode is a tracking mode, and said value corresponds to a predetermined track crossing speed.

8. The system as recited in claim 1, wherein said control circuit comprises an equalizer and a motor control block, said equalizer to provide an output signal in response to said reflected beam, said motor control block to provide a step signal in response to said output signal, said step signal having a magnitude value and a directional value.

9. The system as recited in claim 8, wherein said motor control block further comprises a stepping position counter and a stepping table, said stepping position counter being incremented or decremented in accordance with said directional value of said step signal, to provide a count value to said stepping table, said stepping table to provide a digital value corresponding to a predetermined number of tracks to traverse.

10. The system as recited in claim 9, wherein said motor control block further comprises a digital control oscillator, said digital control oscillator to provide a digital control output in response to said magnitude value of said step signal, said digital control output to provide a clock signal for said stepping position counter.

11. A method for providing step motor control in an optical storage medium, comprising:
generating a beam of light;
reflecting said beam of light off an optical disk having a plurality of tracks;
detecting said reflected beam;
providing said reflected beam to a control circuit;
providing, by said control circuit, a step signal in response to said reflected beam, said step signal having a value corresponding to an operational mode of said control circuit; and,
providing a step motor to said light source across said disk by a predetermined step based on said step signal.

12. The method as recited in claim 11, wherein in providing said step signal, said operational mode is a seek mode, and said value corresponds to a predetermined number of tracks to traverse.

13. The method as recited in claim 12, wherein in providing said step signal, said seek mode is a fine seek mode.

14. The method as recited in claim 12, wherein in providing said step signal, said seek mode is a rough seek mode.

15. The method as recited in claim 14, wherein said act of providing said step signal further comprises initiating said rough seek mode manually through user input.

16. The method as recited in claim 14, wherein said act of providing step signal further comprises initiating said rough seek mode automatically.

17. The method as recited in claim 11, wherein in providing said step signal, said operational mode is a tracking mode, and said value corresponds to a predetermined track crossing speed.

18. The method as recited in claim 11, wherein said act of providing said step signal further comprises providing an equalizer and a motor control block, said equalizer to provide an output signal in response to said reflected beam, said motor control block to provide a step signal in response to said output signal, said step signal having a magnitude value and a directional value.

19. The method as recited in claim 18, wherein in said act of providing said step signal, said motor control block further comprises a stepping position counter and a stepping table, said stepping position counter being incremented or decremented in accordance with said directional value of said step signal, to provide a count value to said stepping table, said stepping table to provide a digital value corresponding to a predetermined number of tracks to traverse.

20. The method as recited in claim 19, wherein in said act of providing said step signal, said motor control block further comprises a digital control oscillator, said digital control oscillator to provide a digital control output in response to said magnitude value of said step signal, said digital control output to provide a clock signal for said stepping position counter.
